(19) United States
(12) Patent Application Publication
(10) Pub. No.: US 2007/0171072 A1
(43) Pub. Date: Jul. 26, 2007

(54) Antenna for livestock detection

(76) Inventor: Robert Wyld, Asburton Victoria (AU)

Correspondence Address: EDWIN D. SCHINDLER, FIVE HIRSCH AVENUE, P.O. BOX 966, CORAM, NY, 11727-0966, US

(21) Appl. No.: 11/571,080

(22) PCT Filed: Jun. 23, 2005
(86) PCT No.: PCT/AU05/00906

§ 371 Date: Feb. 20, 2007

(30) Foreign Application Priority Data
Jun. 23, 2004 (AU) 2004903402

(51) Int. Cl. G08B 13/14; G08B 23/00

(52) U.S. Cl. 340/572.7; 340/572.8; 340/573.3

(57) ABSTRACT

An antenna device for detecting a radio frequency identification device, includes an antenna or aerial embedded in a flexible material, so that when the antenna device is placed in the path of any animal or object carrying a radio frequency identification device, the antenna device flexibly contacts the animal, or object, as it passes.

### AREA OF THE INVENTION

This invention relates to the area of equipment for identifying livestock and in particular to an improved antenna for transmitting a signal for energising an identification transponder and receiving the resultant signal.

### BACKGROUND TO THE INVENTION

The cattle industry, and more recently the sheep industry, have commenced using Radio Frequency Identification Devices to identify and track animals. This is part of the development of a National Livestock Identification Scheme (NLIS) database which is used to store information about livestock having an accredited radio frequency identification device (RFID) each of which is embedded with an electronic transponder permanently encoded with a unique number which number is linked to a particular animal.

While the invention can be used for many applications it will be discussed, for convenience's sake here in terms of identifying cattle.

The animal is generally fitted with a button tag in the ear or alternatively a rumen pellet which has the advantage that it is less easily removed. External readers are generally rigid panels attached to the side of a cattle crush or race which emit an electromagnetic field which induces a charge in a transponder which then responds with a signal which is detected by the reader.

Most cattle handling is effected in environments which are largely of steel, such as cattle races and cattle crushes, however the ability of a reader to induce a charge in the transponder is adversely affected by steel or other conductive materials.

Some ways of ameliorating this problem have been to use a timber section in the race or crush and mount a panel style reader on the outside of the race or crush. Alternatively smaller panel readers can be tuned to a specific steel environment however these cannot be used generally in any other location than the specific situation for which they are tuned.

In addition it can be particularly difficult for external readers to generate a signal from an RFID located in the rumen of any given animal. Some means of attempting to overcome these problems have been to have panel readers on either side of a cattle crush or race as well as above it. Alternatively very large panel readers have been used, None of these methods have been particularly reliable or versatile in that they are generally not adapted to suit multiple types of animal location,

### OUTLINE OF THR INVENTION

It is an object of this invention to provide a reader antenna arrangement which largely ameliorates the abovementioned problems and is more generally adaptable to different locations and applications than previous such readers.

The invention is an antenna device for detecting a radio frequency identification device which includes an antenna or aerial embedded in a flexible material such that, when the device is placed in the path of any animal or object carrying such an identification device, the antenna device flexibly contacts the animal or object as it passes.

It is preferred that the flexible material be rubber and that it be generally in a panel form.

It is further preferred that, where an animal is wearing the radio frequency identification device, the reader extend inwards from at least one side of a race or crush.

It is also preferred that the reader of the invention be able to be mounted wherever required such as a transport truck. It is preferred also that the reader extend into an aperture through which an animal passes.

In order that the invention may be more readily understood we will describe by way of non limiting example a specific embodiment of the invention with reference to the accompanying drawings.

### BRIEF DESCRIPTION OF THE DRAWING FIGURES

FIG. 1 Shows an example of the reader antenna device of the invention;

FIG. 2 Shows the antenna devices mounted on opposing sides of a 3 track race;

FIG. 3 Shows the antenna devices of the invention mounted at the rear of an animal transport truck and at an angle to one and other;

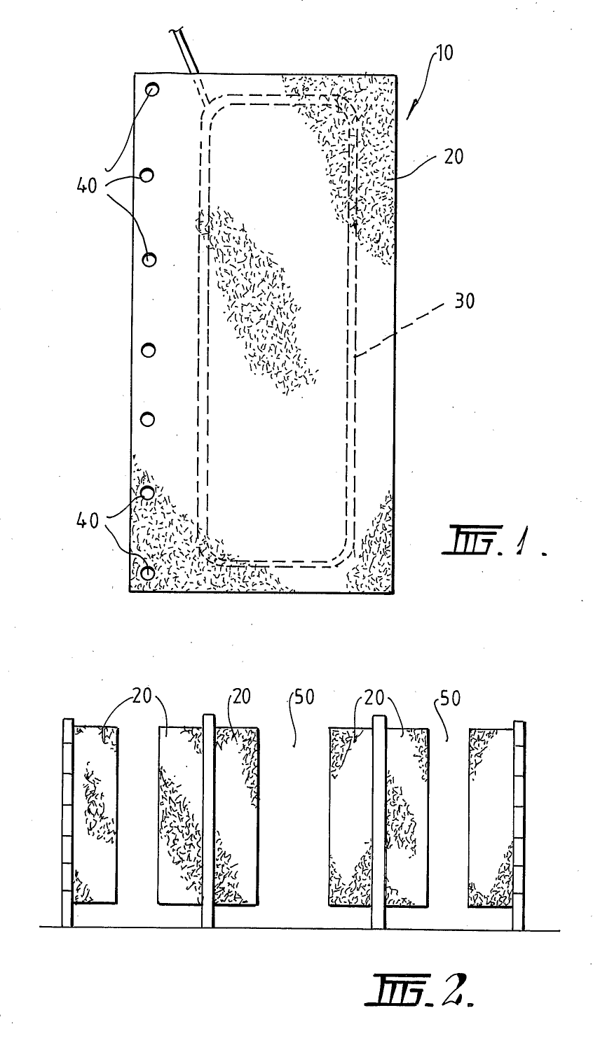

### DESCRIPTION OF AN EMBODIMENT OF THE INMVENTION

The invention 10, in one embodiment where it relates to detecting the RFID details of cattle or the like where they pass though a cattle crush or race, is a rubber panel device 20 which encases an antenna 30 which, in a particular given example, is a continuous aerial loop generally of the order of 570 mm high and 140 mm wide which is mounted approximately 70 mm interior to the edge of holes 40 in the rubber reader device for affixing it to the side of a cattle crush or race. The antenna 30, or loop of cable, in this embodiment of the invention consists of 5 windings of OFC cable that has a rectangular profile dimensioned approximately 2 mm by 5 mm. This loop of electrical cable has tails approximately 3 m in length extending from the rubber panel.

None of these dimensions are however limiting in the invention and can be adapted for any particular application. The coverage suggested above is that found to be appropriate for mechanical stability when the panel bends and is for use with cattle, smaller panels are used for sheep detection.

The antenna device is rectangular when used in a rectangular race, crush or doorway and extends into the aperture through which an animal passes through a distance approximately half the width of the aperture. The arrangement is such that the animal brushes past the antenna device which bends and makes good contact with the animal thereby making it a much simpler matter to detect ear and rumen RFID's.

In the above example the antenna device is mounted such that it is adjacent the side of the animal which has the ear tag if that is the sensor used.

The shape of the antenna device can vary to suit a particular application and where for example the race or crush is generally V shaped the antenna device will be shaped accordingly. The concept of the invention is that a flexible reader is provided in the path of an animal rather than in a fixed panel parallel to its direction of travel. The material from which the reader is made is not limiting in the invention although in this embodiment rubber is preferred.

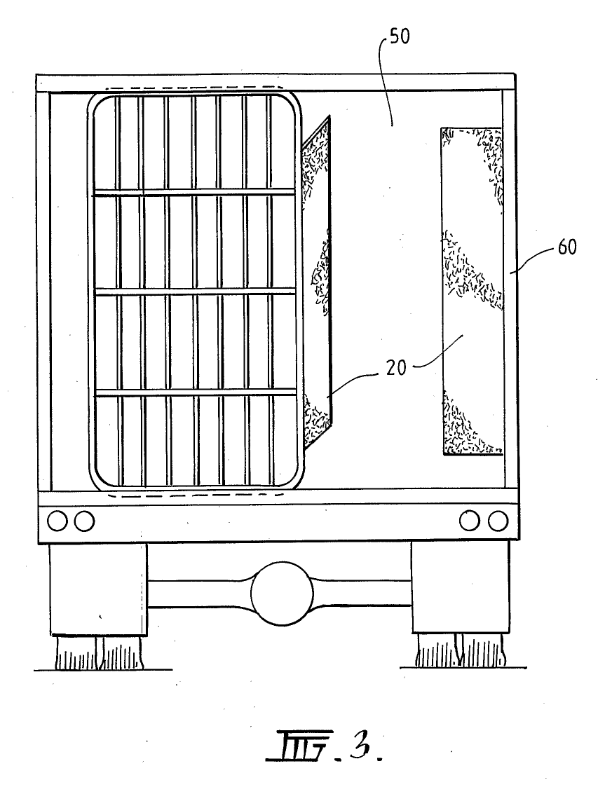

It may also be preferred that antenna devices be provided on opposing sides of a crush or race and an example of this is shown in FIG. 2 where two such devices are provided in the path of animals in a multi-track race.

The concept of the invention is not restricted to any particular location and can be applied in many locations where it is desirable to track livestock movement. In particular it is envisaged that animals being transported on trucks (FIG. 3) can be scanned and identified as they are loaded through an entry 50 onto a vehicle 60 and also identified when they reach their destination.

It may also be preferred that the antenna devices not be oriented in the same plane as each other as a better result may be obtained where they are mounted at an angle to each other and, inthe example shown in FIG. 3 they may be virtually orthogonal. It is also not essential that an animal actually contact an antenna device as close proximity may be sufficient to detect the animal. The flexible nature of the device however does prevent damage due to contact with animals.

By means of the reader of the invention identification of livestock on all manner of transport and in all manner of environments can be achieved relatively simply and as previously stated the invention is not restricted to use with livestock handling only but could be adapted to monitor the movement of any appropriately tagged object such as boxed objects or the like.

While we have described herein one specific embodiment of the invention it is envisaged that other embodiments of the invention will exhibit any number of and any combination of the features of those previously described and it is to be understood that variations and modifications in this can be made without departing from the spirit and scope of the invention.

1-10. (canceled)

11. An antenna apparatus for detecting passing animals, such as livestock, or passing objects, comprising:
an antenna made of a flexible material; and,
a radio frequency identification device emitting a radio frequency and able to be carried by a passing animal or object, so that when said antenna is placed in a path of the passing animal or object carrying said radio frequency identification device, said antenna flexibly contacts the passing animal or object as the animal or object passes.

12. The antenna apparatus according to claim 11, wherein said antenna is embedded in a flexible material.

13. The antenna apparatus according to claim 12, wherein said flexible material is rubber.

14. The antenna apparatus according to claim 11, further comprising additional antennas with each additional said antenna being oriented at an angle to one another.

15. The antenna apparatus according to claim 11, wherein said antenna is formed as a panel.

16. The antenna apparatus according to claim 11, further comprising a race or crush with said antenna extending inwardly from at least one side of said race or crush.
